(19) United States
(12) Patent Application Publication
(10) Pub. No.: US 2013/0206391 A1
(43) Pub. Date: Aug. 15, 2013

(54) Apparatus and System for a Vortex Three Port Container

(71) Applicant: Alexandre Gordon, Aberdeen (GB)

(72) Inventor: Alexandre Gordon, Aberdeen (GB)

(73) Assignee: CAMERON INTERNATIONAL CORPORATION, Houston, TX (US)

(21) Appl. No.: 13/370,471

(22) Filed: Feb. 10, 2012

(51) Int. Cl. E21B 27/00; B01D 17/038

(52) U.S. Cl. 166/162; 210/512.1

(57) ABSTRACT

A three port vortex container to collect liquid samples from the production flow line of an oil reservoir. The device includes a three port vortex container used to separate the gas and liquid phases from a multiphase production flow. Multiphase flow is received by the container, inducing a vortex where the gas and liquid phases are separated due to their varying densities. The device further includes a sampling system where a pressurizing device is used to create a pressure differential across the sampling circuit, directing a fluid flow into the three vortex container. The liquid flow is then directed into a sampling container.

### BACKGROUND

During the lifespan of an oil reservoir, samples from the reservoir can be collected and analyzed. In order to effectively sample the production fluid from a subsea well, sampling systems are often located subsea, in close proximity to the wellhead. Wellhead sampling presents a challenge due to the potential for dispersed and mist flow from the wellhead containing both liquid and gas phases (multiphase flow). In order to properly sample multiphase flows the liquid phase must be separated from the gas phase. Multiphase flows exhibiting a dispersed or mist flow regime can be difficult to separate into component liquid and gas phase flows, in turn making the collection of liquid-only samples more difficult.

### SUMMARY

Embodiments of the apparatus and system disclosed can be used for effective and reliable separation of the liquid and gas phase components, even under conditions of high flow rates or high gas fractions where a dispersed or mist flow regime for a multiphase flow exists. Some embodiments relate to a vortex three port separator while others relate to a system for multiphase sampling incorporating a vortex three port container.

The present disclosure teaches a vortex container for separating an inputted multiphase fluid flow including a more dense phase and a less dense phase. The vortex container includes a container with a curved inner surface, an internal volume, and three ports. The three ports include: (1) a multiphase fluid flow inlet port disposed at an angle to the inner surface of the container; (2) a gas outlet port located at the top of the container; and (3) a liquid outlet port located axially below the intersection of the inlet port's central axis with the container's central axis. The angle of the inlet port is configured to cause the inputted multiphase flow to form a vortex such that the more dense phase separates from the less dense phase along the inner surface of the container due to the relative densities of the phases.

In one embodiment of the vortex container, the internal volume of the container is cylindrical.

In one embodiment, the multiphase inlet port may be disposed at an angle relative to the container's central axis. For example, the inlet port may be angled so that the fluid flow is directed tangentially to the container's inner surface. The inlet port may also be angled toward the liquid outlet port or it may be angled approximately perpendicular to the container's central axis. In another embodiment, the gas outlet port may be disposed coaxially with the container's central axis.

The present disclosure also provides for a system of obtaining liquid production samples from an oil reservoir. The system includes an inlet pipe carrying multiphase process fluid and a vortex chamber including a curved inner surface and an internal volume that receives the multiphase fluid flow through an inlet port. The inlet port is angled to the container's inner surface, inducing a vortex such that the more dense phase separates from the less dense phase along the inner surface of the container due to the relative densities of the phases. The separated less dense phase flows through a gas outlet port at the top of the container and then through a gas flow pipe coupled to the outlet port. The separated more dense phase flows through a liquid outlet port disposed axially below the intersection of the inlet port's central axis with the container's central axis and then through a liquid flow pipe coupled to the liquid outlet port.

In one embodiment of the sampling system, the inlet port of the vortex container may be disposed at an angle relative to the container's central axis. The inlet port may also be angled toward the liquid outlet port or it may be angled approximately perpendicular to the container's central axis. In another embodiment, the gas outlet port may be disposed coaxially with the container's central axis. The inlet port may also be angled so that the fluid flow is directed tangentially to the container's inner surface.

In one embodiment of the sampling system, the internal volume of the container is cylindrical.

In one embodiment of the sampling system, the system includes a pressurization device that may comprise a pump.

The sampling system may further comprise a sampling chamber, such as a sampling container, downstream from the liquid outlet port of the vortex container that collects the more dense phase fluid samples. Once the samples have been collected, the sampling chambers may be isolated from the sampling system, retrieved from subsea via an ROV and brought to the surface, allowing the samples to be analyzed, followed by the sampling chambers being returned subsea and reinstalled in the sampling system.

The production well is typically a subsea well but the invention is equally applicable to topside wells.

### BRIEF DESCRIPTION OF THE DRAWINGS

For a detailed description of the preferred embodiments of the invention, reference will now be made to the accompanying drawings in which:

FIG. 1 is an isometric drawing for an embodiment of a vortex chamber.

FIG. 2 is a view facing the top surface of the vortex chamber of FIG. 1.

FIG. 3 is a cross-sectional view of the vortex container of FIG. 1.

FIG. 4 is a cross sectional view detailing the inlet port and gas outlet port of the vortex container of FIG. 1.

FIG. 5 is a diagrammatic view of an embodiment for a vortex three port container within a sampling system.

FIG. 6 is a diagrammatic view of an embodiment for a multiphase fluid sampling system including a sampling container.

### DETAILED DESCRIPTION

The following discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Any use of any form of the terms “connect,” “engage,” “couple,” “attach,” or any other term describing an interaction between elements is not meant to limit the interaction to direct interaction between the elements and may also include indirect interaction between the elements described. The term “fluid” may refer to a liquid or gas and is not solely related to any particular type of fluid such as hydrocarbons. The terms “pipe,” “conduit,” “line” or the like refers to any fluid transmission means. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. The various characteristics above, as well as other features and characteristics described in more detail below, will be readily apparent to those skilled in the art upon reading the following detailed description of the embodiments, and by referring to the accompanying drawings.

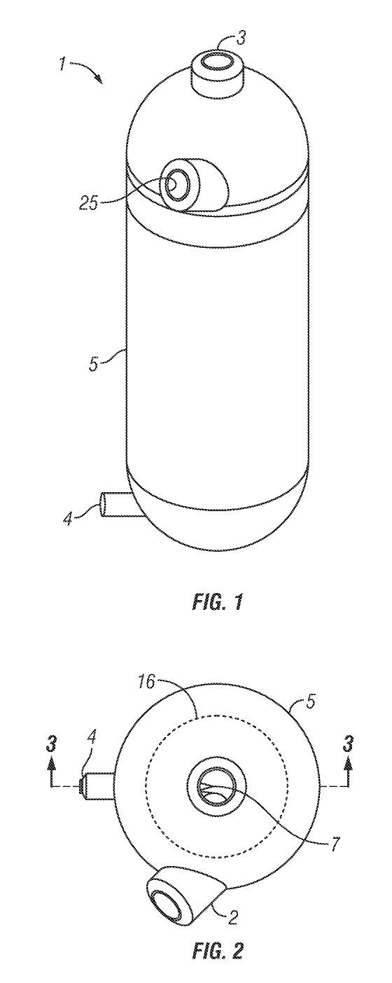

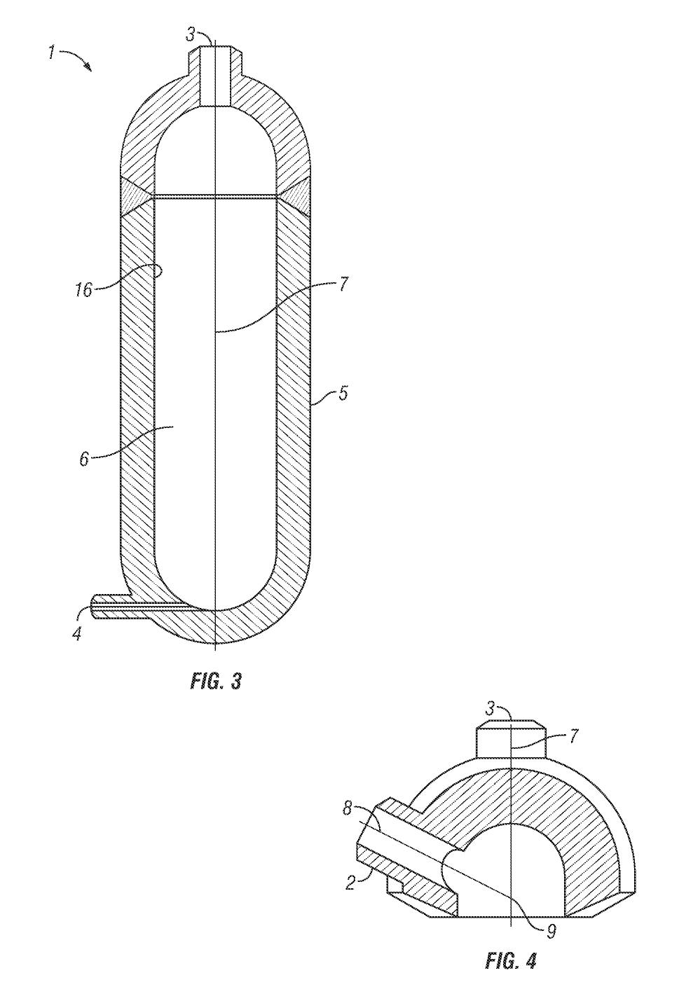

FIGS. 1-4 show an embodiment for a vortex container 1 that includes a multiphase inlet port 2, a gas outlet port 3, a liquid outlet port 4, and container 5. Referring now to FIG. 2, the multiphase inlet port 2 of container 5 is shown angled to the container's inner surface 16. The angled relationship causes the entering fluid to enter into a vortex, with the more dense phase forced to rotate along a wider radius around the container's central axis 7 (orthogonal to the page) than the less dense phase due to the increased centrifugal force acting on the liquid. In FIGS. 1 and 3 the liquid outlet port 4 is shown located below the inlet port 2. The more dense phase travels to the bottom of the container 5 as it travels along the inner surface 16 of the container 5. When the more dense fluid reaches the lower part of the container 5 it collects there, so it can drain or be drained from the liquid outlet port 4.

FIG. 3 shows the vortex container 1 with container 5 containing a cylindrical internal volume 6, a container central axis 7, gas outlet port 3, and liquid outlet port 4. The gas outlet port 3 is located at or near the top of the container 7 and may be disposed coaxially with the central axis of the container 7. Having the gas outlet port 3 disposed coaxially with the container's central axis 7 may increase the effectiveness of the vortex container 1 as the radially centered area of the vortex contains the least dense fluid due to it having the least amount of centrifugal force acting on it when flowing along the curved inner surface 16. This design thus provides a direct channel for the less dense phase inside the chamber 1 to vent through the gas outlet port 3. However, it should be appreciated that the gas outlet port 3 may be positioned other than coaxially with the container's central axis 7 as long as the vortex container 1 is effective in allowing the less dense fluid in the container 1 to vent through the gas outlet port 3. It should be further appreciated that the internal volume 6 of the container 5 may be other than cylindrical in shape as long as the container has a curved inner surface.

FIG. 4 shows a cross-sectional view of the top portion of a vortex container including a multiphase inlet port 2, gas outlet port 3, container central axis 7, inlet port central axis 8, and the intersection point 9 of the inlet port's central axis 8 with respect to the container's central axis 7. The gas outlet port 3 is located at or near the top of the container 7 and may be disposed coaxially with the central axis of the container 7. Referring now to FIGS. 3 and 4, the liquid outlet port 4 resides below the intersection point 9.

As shown in FIGS. 2 and 4, the inlet port 2 angled to the curved inner surface of the container 16. The angle of the inlet port 2 directs the multiphase flow radially outward due to being angled to the container's curved inner surface 16. Further, the inlet port 3 may be angled toward the liquid outlet port 4, ensuring that the more dense flow does not escape through gas outlet port 3. In other embodiments, the inlet port 3 may be angled approximately perpendicular to the container's central axis 7. The inlet port 3 may also be angled tangentially to the curved inner surface 16.

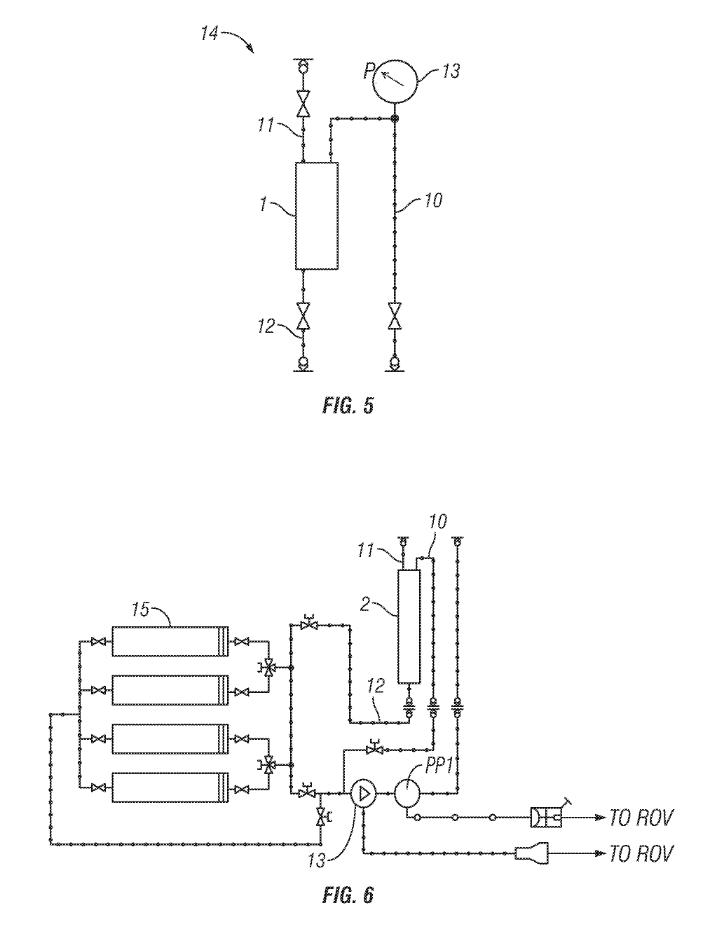

Referring now to FIG. 5, this schematic illustrates an embodiment for a multiphase flow sampling system 14 comprising a pressure gauge 13, a multiphase flow pipe 11, a vortex container 1, a gas flow pipe 10, and a liquid flow pipe 12. There is a pressure differential generated within the sampling system 14, forcing a multiphase fluid flow through multiphase flow pipe 11 into the vortex container 1. The design of the chamber 1 induces a vortex, separating the less dense and more dense phases of the multiphase flow as described above. The less dense phase exits through the gas flow pipe 10 and back topside where it may be vented. The more dense phase is collected within the vortex container 1 and drains through the liquid flow pipe 12. It should be appreciated that a pump is not necessary to create the flow into the chamber 1, and that any appropriate device may be used.

Referring now to FIG. 6, this embodiment for a sampling system 18 features a pump 20, a multiphase flow pipe 11, a vortex container 1, a gas flow pipe 10, a liquid flow pipe 12, and a sampling container 15. In this embodiment, once the more dense flow has been separated, it flows through the liquid flow pipe 12, entering the sampling chamber 15.

It should be appreciated that the sampling systems 14 and 18 may be used for oil or gas wells where the multiphase fluid is production fluid from an oil or gas well. The systems 14 and 18 may also be used where the oil or gas well is a subsea well and the system is located subsea. For example, the sampling chamber 15 may store the collected liquid sample for a period of time before the chamber 15 is retrieved, possibly through the use of a ROV, and brought back topside where the liquid sample may be analyzed. Although the present invention has been described with respect to specific details, it is not intended that such details should be regarded as limitations on the scope of the invention, except to the extent that they are included in the accompanying claims.

What is claimed:

1. A vortex container for separating an inputted multiphase fluid flow including a more dense phase and a less dense phase, including:
a container with an internal volume including a curved inner surface;
an inlet port configured to input the multiphase fluid flow into the internal volume of the container, the inlet port including a central axis angled to input the multiphase fluid flow tangentially to the inner surface of the container;
a less dense phase outlet port configured to output a separated less dense phase flow, located at the top of the container;
a more dense phase outlet port configured to output a more dense phase flow, located below the intersection between the inlet port's central axis and the container's longitudinal axis; and
where the angle of the inlet port is configured to cause the inputted multiphase flow to form a vortex such that the more dense phase separates from the less dense phase along the inner surface of the container due to the relative densities of the phases.

2. The vortex container of claim 1, wherein the internal volume of the container is cylindrical.

3. The vortex container of claim 1, wherein the central axis of the inlet port is disposed at an angle relative to the container's central axis.

4. The vortex container of claim 1, where in the more dense phase of the multiphase fluid flow includes a liquid.

5. The vortex container of claims 1, where the less dense phase of the multiphase fluid flow includes a gas.

6. The vortex container of claim 1 where the inlet port is angled toward the more dense phase outlet port.

7. The vortex chamber of claim 1 where the inlet port is angled approximately perpendicular to the container's central axis.

8. The vortex container of claim 1, wherein the less dense phase outlet port is disposed coaxially with the container's central axis.

9. A system for sampling a multiphase stream, including:
a pipe carrying a multiphase fluid flow;
a vortex container for separating an inputted multiphase fluid flow including a more dense phase and a less dense phase, including:
a container with an internal volume including a curved inner surface;
an inlet port configured to input the multiphase fluid flow into the internal volume of the container, the inlet port including a central axis angled to the inner surface of the container;
a less dense phase outlet port configured to output a separated less dense phase flow, located at the top of the container;
a more dense phase outlet port configured to output a more dense phase flow, located below the intersection between the inlet port's central axis and the container's longitudinal axis; and
where the angle of the inlet port is configured to cause the inputted multiphase flow to form a vortex such that the more dense phase separates from the less dense phase along the inner surface of the container due to the relative densities of the phases;
a less dense phase flow pipe coupled to the less dense phase outlet port and receiving the separated less dense phase flow; and
a more dense phase flow pipe coupled to the more dense phase outlet port and receiving the separated more dense phase flow.

10. The system of claim 9, wherein the internal volume of the container is cylindrical.

11. The system of claim 9, wherein the central axis of the vortex container's inlet port is disposed at an angle relative to the container's central axis.

12. The system of claim 9, wherein sampling a multiphase fluid stream further includes a sampling container to collect sampled fluids, coupled to the more dense phase flow pipe.

13. The system of claim 9, further including a pressurization device coupled to the inlet flow pipe to create a pressure differential across the sampling system.

14. The system of claim 13, wherein the pressurization device is a pump.

15. The system of claim 9 where the inlet port is angled toward the more dense phase outlet port.

15. The system of claim 9 where the inlet port is angled approximately perpendicular to the container's central axis.

17. The system of claim 9 where the less dense phase outlet port is disposed coaxially with the container's central axis.

18. The system of claim 9 where the multiphase fluid is production fluid from an oil or gas well.

19. The system of claim 18 where the oil or gas well is a subsea well and the system is located subsea.
